(19) United States
(12) Patent Application Publication
(10) Pub. No.: US 2023/0146633 A1
(43) Pub. Date: May 11, 2023

(54) SYSTEMS AND METHODS FOR SECURE COMMUNICATION BETWEEN COMPUTING DEVICES OVER AN UNSECURED NETWORK

(71) Applicant: CUCULAN LLC, Reno, NV (US)

(72) Inventor: Roy Keith Weaver, Reno, NV (US)

(73) Assignee: CUCULAN LLC, Reno, NV (US)

(21) Appl. No.: 17/984,580

(22) Filed: Nov. 10, 2022

Related U.S. Application Data
(60) Provisional application No. 63/277,791, filed on Nov. 10, 2021.

(51) Int. Cl. H04L 9/40

(52) U.S. Cl. CPC H04L 63/0428

(57) ABSTRACT

Techniques for securing communication between a plurality of network computing devices over an unsecured network can include providing a plurality of communication security devices in secure communication with the network computing devices. A list of authorized communication devices can be established that specifies one or more computing devices with which each of the plurality of network computing devices are authorized to communicate. A communication packet from a source network computing device will specify a destination network computing device. A communication security device that receives the packet will transmit the packet to another communication security device associated with the intended destination network computing device when the network computing devices are authorized to communicate. The other communication security device will transmit the packet to the intended destination network when the network computing devices are authorized to communicate. When the source and destination are not authorized to communicate, the packet will be discarded.

### CROSS-REFERENCE TO RELATED APPLICATIONS

This application claims the benefit of U.S. Provisional Application No. 63/277,791, filed on Nov. 10, 2021. The disclosure of the above application is incorporated herein by reference in its entirety.

### FIELD

The present disclosure relates to communication security and, more particularly, to techniques for ensuring secure communication between computing devices over an unsecured network.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In conventional network communication, network resources communicate over a network, which may be secured or unsecured. As its name suggests, a secured network can provide a higher level of security than an unsecured network. Accordingly, many local area networks (LANs) are set up as secure networks through which network resources can securely communicate with each other. While providing many benefits, such secure LANs may also have disadvantages and/or security vulnerabilities. For example only, LANs may be limited in geographic scope such that network resources cannot utilize a LAN to secure other network resources that are remotely located and administrated.

Unsecured networks may not have such geographic restrictions, but can have other disadvantages. Many network security devices, protocols, software, etc. exist to provide increased security in communication over unsecured networks, e.g., firewalls, intrusion protection systems, email security gateways, and network access control protocols. While providing an increase over completely unsecured network communication, existing network security techniques also have disadvantages and vulnerabilities. In typical network security techniques, the source of a communication packet can be spoofed such that techniques that authorize communication based on the source of the packet can be tricked into transmitting malicious packets. In other example, some conventional network security techniques scan the data/content of transmitted communication packets to detect malicious messages. While such data scanning may detect known malicious or harmful code, such data scanning may not detect new or unknown malicious code and/or may not work with encoded data.

Based on the above, a need exists for improved communication techniques that provide increased security and address the above noted, and other, deficiencies in conventional systems.

### SUMMARY

In various implementations of the present disclosure, a computer-implemented method of securing communication between a plurality of network computing devices over an unsecured network is disclosed. The method can include providing a plurality of communication security devices. The plurality of communication security devices can include: (i) a first communication security device in secure communication with a first network computing device of the plurality of network computing devices, and (ii) a second communication security device in secure communication with a second network computing device of the plurality of network computing devices. The method can further include establishing a list of authorized communication devices that specifies one or more computing devices with which each of the plurality of network computing devices are authorized to communicate. A communication packet can be received at the first communication security device and from the first network computing device. The communication packet can include first destination information that specifies that the communication packet is intended to be delivered to the second network computing device.

The method can also include determining, at the first communication security device and based on the destination information and the list of authorized communication devices, whether the first network computing device is authorized to communicate with the second network computing device. When the first network computing device is authorized to communicate with the second network computing device, the method can comprise encapsulating, at the first communication security device, the communication packet to obtain an encapsulated communication packet. The encapsulated communication packet can comprise: (i) the communication packet, and (ii) second destination information that specifies that the encapsulated communication packet is intended to be delivered to the second communication security device in order for the communication packet to be delivered to the second network computing device. The method can further include transmitting, from the first communication security device and to the second communication security device over the unsecured network, the encapsulated communication packet, and de-encapsulating, at the second communication security device, the encapsulated communication packet to obtain the communication packet. Additionally, the method can include determining, at the second communication security device and based on the destination information and the list of authorized communication devices, whether the second network computing device is authorized to communicate with the first network computing device, and when the second network computing device is authorized to communicate with the first network computing device, transmitting, from the second communication security device, the communication packet to the second network computing device.

In some aspects, the method can further comprise, when the first network computing device is not authorized to communicate with the second network computing device, discarding the communication packet at the first communication security device without passing on the communication packet.

In some aspects, the first communication security device is in secure communication with the first network computing device via a physical communication link.

In some aspects, the list of authorized communication devices specifies which of the plurality of communication security devices is to be utilized to communicate with each of the plurality of network computing devices.

In some aspects, the method can further comprise transmitting, from the first communication security device, a periodic heartbeat signal to the second communication security device. The periodic heartbeat signal can indicate to the second communication security device that the first communication security device is in operation.

In some implementations, the plurality of communication security devices includes a third communication security device in secure communication with the first network computing device of the plurality of network computing devices, the third communication security device comprising a backup to the first communication security device for secure communication with the first network computing device. The periodic heartbeat signal can indicate which of the first communication security device or the third communication security device is to be used by the second communication security device to communicate with the first network computing device.

In some aspects, the method can further comprise transmitting, from a configuration management device and to the plurality of communication security devices, a communication configuration that provides or updates the list of authorized communication devices.

In some aspects, the first communication security device and the first network computing device can be integrated into a single physical device.

In some aspects, the establishing the list of authorized communication destinations can comprise storing the list of authorized communication destinations at each of the first and second communication security devices.

In additional implementations of the present disclosure, a secure communication system for securing communication between a plurality of network computing devices over an unsecured network is disclosed. The secure communication system can perform the computer-implemented method of securing communication between a plurality of network computing devices over an unsecured network described above.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example secure communication computing system including a plurality of communication security devices and a plurality of network computing devices communicating over a network according to some implementations of the present disclosure;

FIG. 2 is a functional block diagram of an example network computing device that can comprise the plurality of network computing devices of FIG. 1;

FIGS. 3A-3C is a functional block diagram of an example secure communication computing system illustrating a secure communication transmission example according to some implementations of the present disclosure;

FIGS. 4A-4B is a functional block diagram of an example secure communication computing system illustrating another secure communication transmission example according to some implementations of the present disclosure;

FIGS. 5A-5B is a functional block diagram of an example secure communication computing system illustrating yet another secure communication transmission example according to some implementations of the present disclosure;

FIG. 6 is a flow diagram of an example technique for securing communication between a plurality of network computing devices over an unsecured network according to some implementations of the present disclosure; and

FIG. 7 is a flow diagram of an example technique for failover for a secure communication system that secures communication between a plurality of network computing devices over a according to some implementations of the present disclosure.

### DETAILED DESCRIPTION

As mentioned above, conventional communication security techniques can have disadvantages and/or security vulnerabilities that may be unacceptable for particular communication arrangements. In order to address the above and other disadvantages of known techniques, the present disclosure is directed to improved communication security techniques that utilize a plurality of security communication devices to protect communication between network computing devices over an unsecured network. Each network computing device can be in secure communication with at least one security communication device. In some aspects, the network computing device can be in secure communication with a security communication device via a physical communication link (an Ethernet connection, a fiber or other optical connection, etc.). The security communication devices control communication between network computing devices such that all communications between the network computing devices must pass through a security communication device.

In one example in which a first network computing device communicates with a second network computing device, the first computing device is in secure communication with a first communication security device and the second network computing device is in secure communication with a second security communication device (e.g., via a physical connection link). The first and second security communication devices can communicate with each other over an unsecured network. When the first network computing device sends a packet to the second network computing device, the first security communication device will receive the packet. The packet can comprise destination information (e.g., the address of the second network computing device) and a data or payload portion (e.g., the message or data to be delivered to the destination). The packet can comprise a standard communication packet corresponding to the communication protocol being utilized (Transmission Control Protocol, User Datagram Protocol, and the like). In some aspects, the first network computing device can be unaware of the existence of the first and second network computing devices.

Once the packet is received at the first security communication device, the destination information is interrogated to determine where and whether to further transmit the packet to the destination. The first and second security communication devices can be configured to identify the network computing devices that are authorized to communicate with each other, e.g., by having a list of a list of authorized communication devices. The list of authorized communication devices can specify the network computing devices that are authorized to communicate in the system. The destination (i.e., the second network computing device) specified in the destination information of the packet is compared to the list of authorized communication devices. If the first security communication device identifies the second network computing device as an authorized destination, the first security communication device will further transmit the packet, as described more fully below. If the second network computing device is not an authorized destination, the first security communication device will discard the packet without transmitting it further.

When the first network computing device is authorized to communicate with the second network computing device (that is, when the second network computing device is an authorized destination), the first security communication device can encapsulate the communication packet to obtain an encapsulated communication packet. The encapsulated communication packet can comprise an encrypted version of the original communication packet with new destination information. The new destination information can specify that the encapsulated communication packet is intended to be delivered to the second communication security device in order for the communication packet to be delivered to the second network computing device. For example only, the new destination information can be based on the list of authorized communication devices, which can not only specify the network computing devices that are authorized to communicate in the system but also to which communication security device a packet should be directed in order to be transmitted to the specified network computing device.

As mentioned above, the encapsulated communication packet can comprise an encrypted version of the original communication packet with the new destination information added thereto. An encryption key can be previously shared between communication security devices and stored at the communication security devices for use to both encode and decode the encrypted data. The encapsulated communication packet can then be securely transmitted over an unsecured network. In some implementations, the original communication packet can also be encrypted with an encryption scheme that is shared between the network computing devices and which is unknown to the communication security devices. In this manner, the data of the original communication packet can be doubly encrypted when it is transmitted over the unsecured network.

In some aspects, a configuration management computing device can be in secure communication with each of the communication security devices, e.g., via a physical connection link. The configuration management computing device can manage the communication security devices to implement the system. In some aspects, the configuration management computing device can establish the list of authorized communication devices, which are provided to the communication security devices. In this manner, the configuration management computing device can configure and dynamically re-configure the system during its operation, e.g., to update the list of authorized communication devices. In this manner, the secure communication system can be updated, upgraded, reconfigured, etc. without the network computing devices even being notified of the change.

In some aspects, two or more communication security devices can be associated with a specific network computing device such that there is an “active” communication security device and a “backup” communication security device. In such implementations, each of the communication security devices will be in secure communication with the specific network computing device (e.g., via a physical communication link as described herein). In the event of a failure of the “active” communication security device (such as during an equipment failure, or during the repair or replacement of a security communication device), the “backup” communication security device can change to an “active” status. In some aspects, the communication security devices can be configured to transmit periodic heartbeat signals to each other and/or the configuration management computing device in order to detect a failure of a communication security device.

The secure communication system of the present disclosure, as described herein, can provide various benefits over conventional systems. As mentioned above, with the disclosed system network computing devices can securely communicate with each other without being aware of the existence of the communication security devices. This can permit updating and/or reconfiguring the security of the secure communication system without any change to the network computing devices connected thereto. Further, the communication security devices of the disclosed system can easily be added to an existing network of computing devices without any reconfiguration of the existing network. These and other benefits of the disclosed systems and methods will be readily apparent to those of skill in the art.

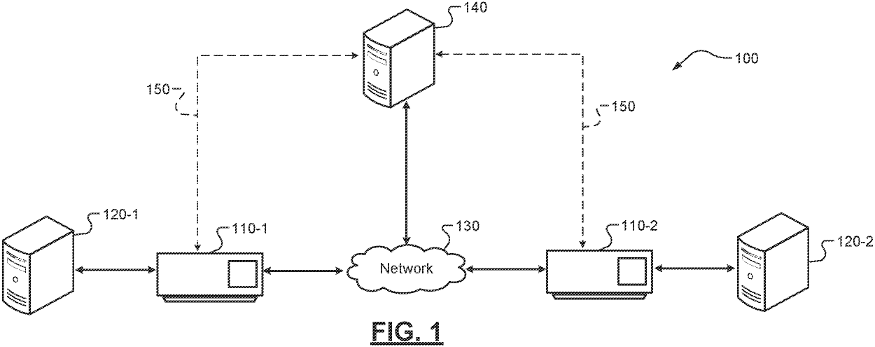

Referring now to FIG. 1, a diagram of an example secure communication computing system 100 is illustrated. The computing system 100 can include a plurality of example communication security devices 110 and a plurality of more example network computing devices 120 that communicate via a network 130 according to some implementations of the present disclosure. Additionally, the secure communication computing system 100 can include one or more configuration management computing devices 140 configured to communicate with the communication security devices 110. For example only, the configuration management computing devices 140 can communicate with the communication security devices 110 via the network 130, via one or more additional secure communication channels 150 (such as a physical connection link), or a combination thereof.

For ease of description, in this application and as shown in FIG. 1, two example communication security devices 110 (a first communication security device 110-1 and a communication security device 110-2) and two example network computing devices 120 (a first network computing device 120-1 and a second network computing device 120-2) are illustrated and described. It should be appreciated, however, that there can be more network computing devices 110, communication security devices 120, and/or configuration management computing devices 140 than is illustrated. While illustrated as a server computing device, each of the network computing devices 110, communication security devices 120, and configuration management computing devices 140 can be any type of suitable computing device, such as a desktop computer, a tablet computer, a laptop computer, a smartphone, or any form of processor. Further, while the communication security devices 110 and the network computing devices 120 are illustrated and described herein as being physically separate devices, it should be appreciated that a communication security device 110 can be integrated into a network computing device 120 such that the combined communication security device 110/network computing device 120 comprises a single physical device. Accordingly, the use of the terms “communication security device 110” and “network computing device 110” is intended to encompass both physically separate devices as well as both devices integrated into a single physical device.

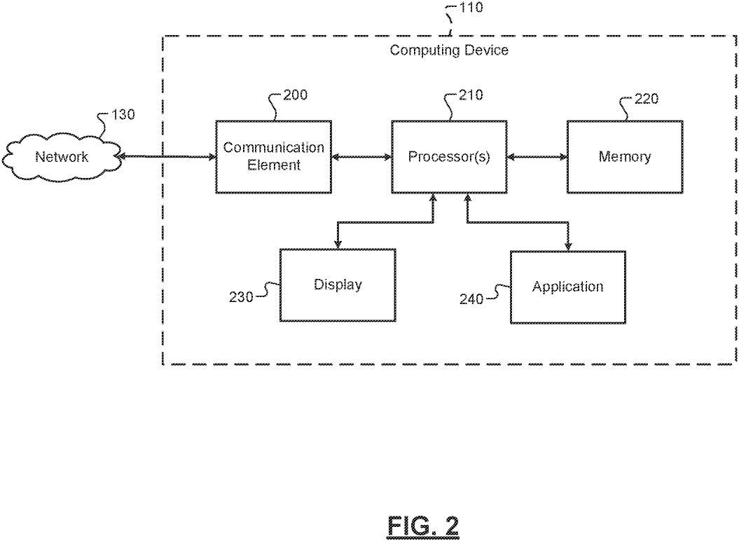

A functional block diagram of an example network computing device 120 is illustrated in FIG. 2. The network computing device 120 can include a communication element 200, one more processors 210, a memory 220, a display device 230, and an application 240 that is being executed (referred to herein as “application 240”). The processor(s) 210 can control operation of the network computing device 120, including implementing at least a portion of the techniques of the present disclosure. The term “processor” as used herein is intended to refer to both a single processor and multiple processors operating together, e.g., in a parallel or distributed architecture. Further, it should be appreciated that the illustrated network computing device 120 is merely an example and can include additional or alternative components.

The communication element 200 can be configured for communication with other devices (e.g., the communication security devices 110 or other network computing devices 120) via the network 130 or other communication medium. One non-limiting example of the communication element 200 is a transceiver, although other forms of hardware are within the scope of the present disclosure. The memory 220 can be any suitable storage medium (flash, hard disk, etc.) configured to store information. For example, the memory 220 may store a set of instructions that are executable by the processor 210, which cause the network computing device 120 to perform operations, e.g., such as the operations of the present disclosure. The display device 230 can display information to a user. In some implementations, the display device 230 can comprise a touch-sensitive display device (such as a capacitive touchscreen and the like), although non-touch display devices are within the scope of the present disclosure.

It should be appreciated that the example communication security devices 110 and configuration management computing devices 140 can include the same or similar components as the network computing device 120, and thus can be configured to perform some or all of the techniques of the present disclosure, which are described more fully below. Further, while the techniques of the present disclosure are described herein in the context of the secure communication computing system 100, it is specifically contemplated that each feature of the techniques may be performed by a network computing device 120 alone, a plurality of network computing devices 120 operating together, a communication security device 110 alone, a plurality of communication security devices 110 operating together, a configuration management computing device 140 alone, a plurality of configuration management computing devices 140 operating together, and any combination of one or more network computing devices 120, one or more network computing devices 110, and one or more configuration management computing devices 140 operating together.

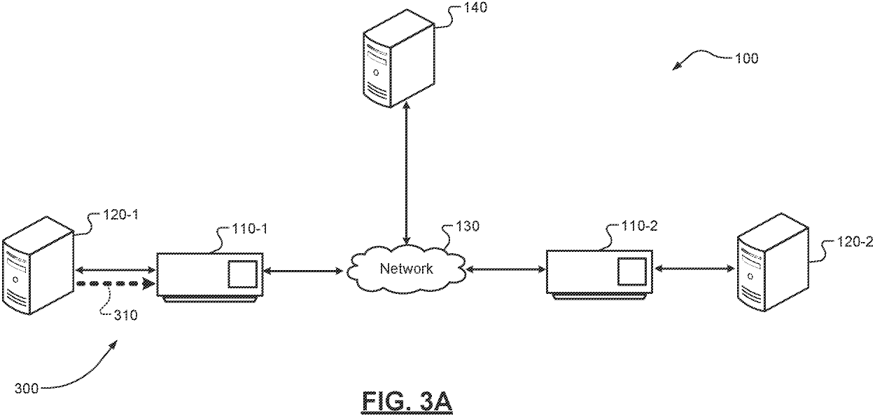

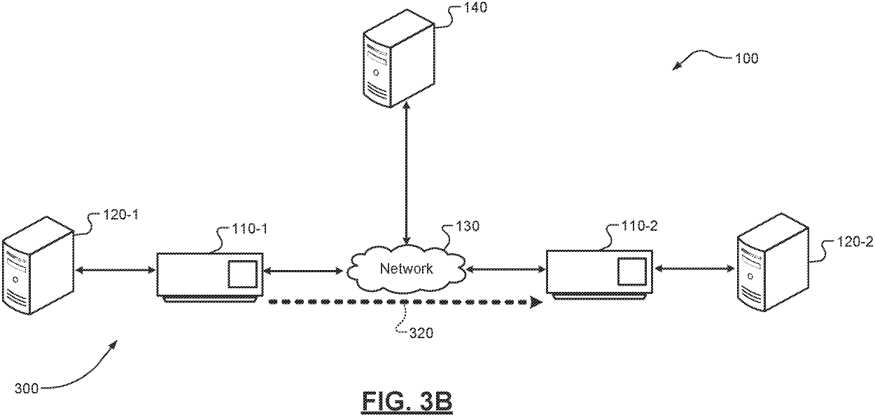

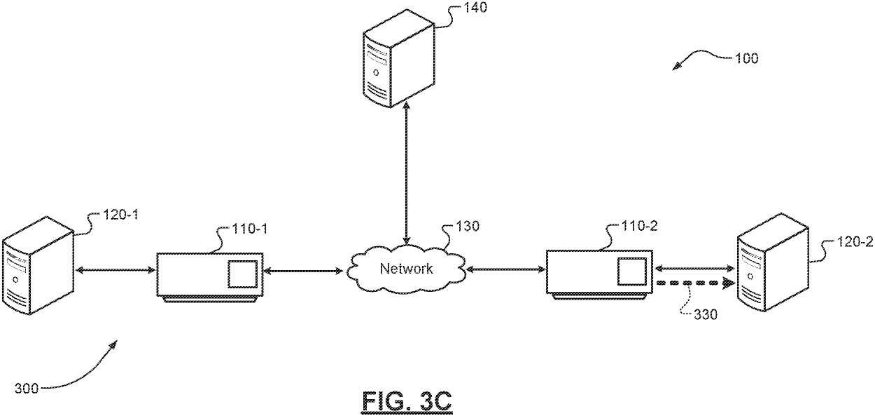

Referring now to FIGS. 3A-3C, 4A-4B, and 5A-5B, an example secure communication computing system 100 illustrating example secure communication transmission processes 300, 400, and 500, respectively, according to some implementations of the present disclosure is shown. The secure communication computing system 100 can be configured to implement the secured communication techniques as described herein. The illustrated secure communication computing system 100 includes a first communication security device 110-1 in secure communication with a first network computing device 120-1 and a second communication security device 110-2 in secure communication with a second network computing device 120-2. The communication security devices 110-1, 110-2 can be configured to include a list of authorized communication devices that specifies one or more computing devices with which each of the first and second network computing devices 120-1, 120-2 are authorized to communicate.

In the example secure communication transmission process 300 illustrated in FIGS. 3A-3C, the secure communication computing system 100 is configured such that the list of authorized communication devices specifies that the first and second network computing devices 120-1, 120-2 are authorized to communicate with each other via the system 100. Accordingly, a communication packet 310 is shown as being transmitted by the first network computing device 120-1 with the intended destination of the second network computing device 120-2. As mentioned above, the communication packet 310 can include first destination information that specifies that the communication packet 310 is intended to be delivered to the second network computing device 120-2, as well as the payload or data that is to be received by the second network computing device 120-2.

Once the communication packet 310 is received at the first communication security device 110-1, the first communication security device 110-1 can determine whether the first network computing device 120-1 is authorized to communicate with the second network computing device 120-2. This determination can be based upon, inter alia, the destination information and the list of authorized communication devices. When the first network computing device 120-1 is authorized to communicate with the second network computing device 120-2, the first communication security device 110-1 can encapsulate the communication packet 310 to obtain an encapsulated communication packet 320. The encapsulated communication packet 320 can comprise the original communication packet 310 as well as new destination information (second destination information) that specifies that the encapsulated communication packet 320 is intended to be delivered to the second communication security device 110-2 in order for the communication packet 310 to be delivered to the second network computing device 120-2. As described herein, the encapsulation of the communication packet 310 can include encrypting the communication packet 310 with an encryption scheme. As shown in FIG. 3B, the first communication security device 110-1 can transmit the encapsulated communication packet 320 to the second communication security device 110-2.

Once the encapsulated communication packet 320 is received at the second communication security device 110-2, the second communication security device 110-2 can de-encapsulate the encapsulated communication packet 320 to obtain the communication packet 310. Based on the communication packet 310, the second communication security device 110-2 can determine whether the first network computing device 120-1 is authorized to communicate with the second network computing device 120-2. Similar to the above, this determination can be based upon, inter alia, the destination information and the list of authorized communication devices. When the first network computing device 120-1 is authorized to communicate with the second network computing device 120-2, the second communication security device 110-2 can transmit the communication packet 310 (illustrated as the de-encapsulated version 330 of the encapsulated communication packet 320 in FIG. 3C) to the second network computing device 120-2. The de-encapsulated version 330 of the encapsulated communication packet 320 can be identical to the original communication packet 310. Alternatively, the de-encapsulated version 330 may contain some different information from the original communication packet 310, such as a checksum, hash, or other transmission specific data corresponding to the communication path between the second communication security device 110-2 and the second network computing device 120-2. Nonetheless, the de-encapsulated version 330 can still contain the same payload or substantively identical data as the original communication packet 310.

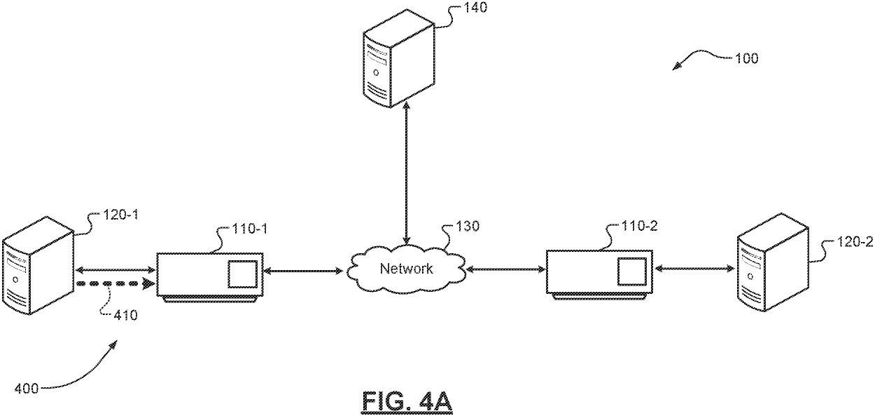

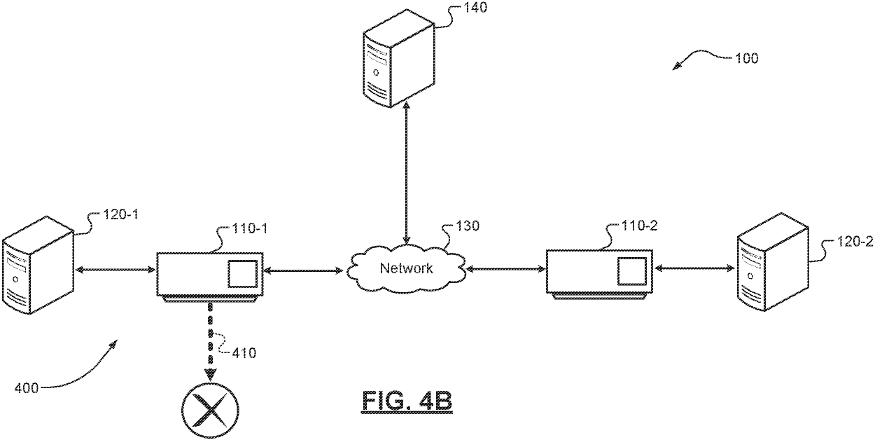

In the example secure communication transmission process 400 illustrated in FIGS. 4A-4B, the secure communication computing system 100 is configured such that the list of authorized communication devices specifies that the first and second network computing devices 120-1, 120-2 are not authorized to communicate with each other via the system 100. Accordingly, a communication packet 410 is shown (FIG. 4A) as being transmitted by the first network computing device 120-1 with the intended destination of the second network computing device 120-2. As mentioned above, the communication packet 410 can include first destination information that specifies that the communication packet 410 is intended to be delivered to the second network computing device 120-2, as well as the payload or data that is to be received by the second network computing device 120-2.

Once the communication packet 410 is received at the first communication security device 110-1, the first communication security device 110-1 can determine whether the first network computing device 120-1 is authorized to communicate with the second network computing device 120-2. This determination can be based upon, inter alia, the destination information and the list of authorized communication devices. As mentioned above, in this example the first network computing device 120-1 is not authorized to communicate with the second network computing device 120-2. Accordingly, the first communication security device 110-1 can discard (FIG. 4B) the communication packet 410 without further passing on the communication packet 410, thereby inhibiting the transmission of the communication packet 410 over the network 130. In this manner, the first communication security device 110-1 can protect the communication packet 410 from reaching its purported destination, i.e., the second network computing device 120-2, as well as protect the communication packet 410 from being transmitted over the network 130.

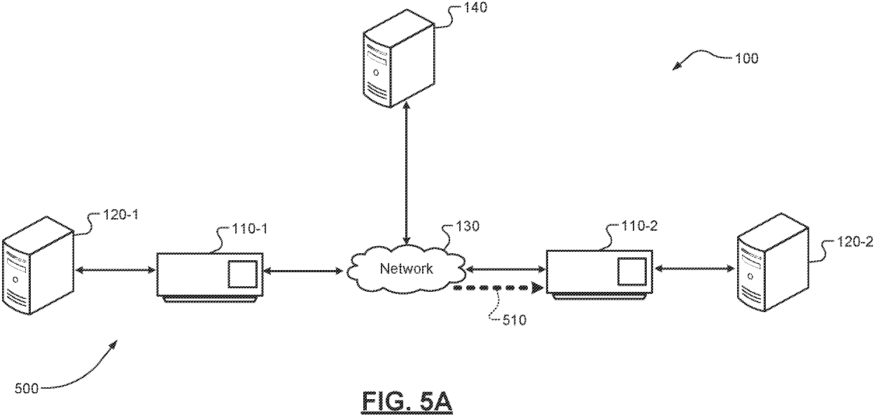

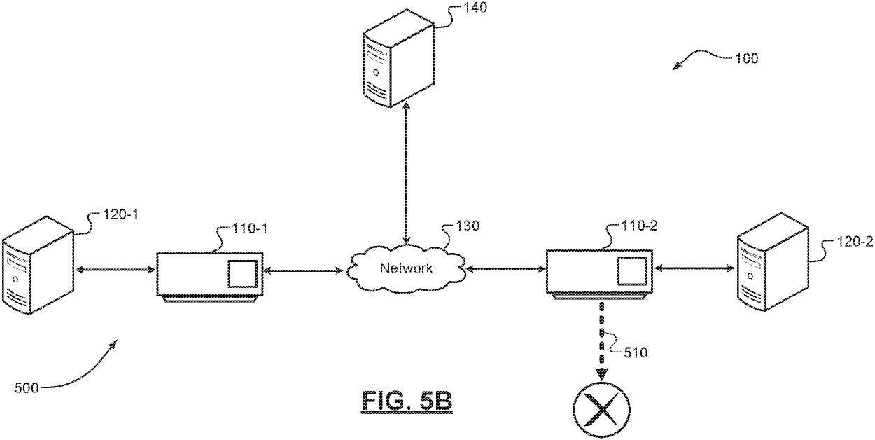

In the example secure communication transmission process 500 illustrated in FIGS. 5A-5B, the secure communication computing system 100 is configured such that the list of authorized communication devices specifies that the first and second network computing devices 120-1, 120-2 are not authorized to communicate with each other via the system 100. Accordingly, a communication packet 510 is shown (FIG. 5A) as being received by the second communication security device 110-2. The communication packet 510 that is received at the second communication security device 110-2 can include data/information that indicates that the source of the communication packet 510 is the first network computing device 120-1. This source information may be accurate, or may be spoofed or otherwise inaccurate (e.g., the communication packet 510 may be from a malicious computing device not associated with the communication system 100).

Once the communication packet 510 is received at the second communication security device 110-2, the second communication security device 110-2 can determine whether the first network computing device 120-1 (i.e., the purported source of the communication packet 510) is authorized to communicate with the second network computing device 120-2. This determination can be based upon, inter alia, the destination information and the list of authorized communication devices. As mentioned above, in this example the first network computing device 120-1 is not authorized to communicate with the second network computing device 120-2. Accordingly, the second communication security device 110-2 can discard (FIG. 5B) the communication packet 510 without further passing on the communication packet 510. In some aspects, the second communication security device 110-2 can include further protections against delivering unauthorized packets to the second network computing device 120-2. For example only, the second communication security device 110-2 will attempt to de-encapsulate/decrypt the communication packet 510, which will fail for an unauthorized packet that has not been encapsulated/encrypted by a valid communication security device 110 in the system 100. Additionally, in some aspects the second communication security device 110-2 may include a time-based protection against a replay attack. It should be appreciated that the techniques described herein can be combined with existing or future developed security processes. In this manner, the second communication security device 110-1 can protect the second network computing device 120-2 from receiving the communication packet 510 and any potential malicious or unwanted data therein.

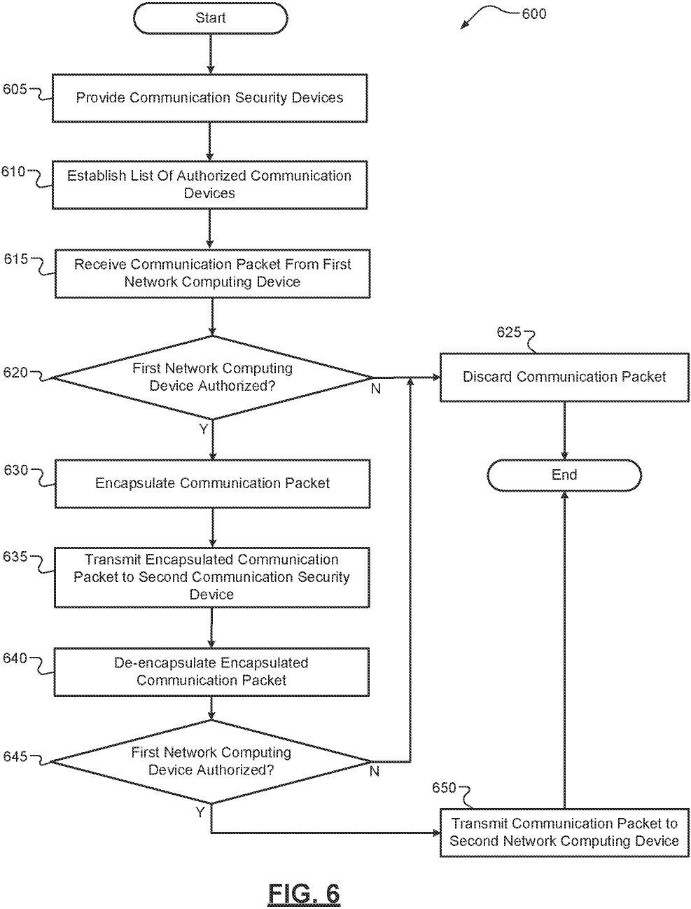

With further reference to FIG. 6, an example computer-implemented method 600 of securing communication between a plurality of network computing devices 120 over a network 130 is disclosed. The method 600 can be performed by any computing device or devices, such as the communication security device(s) 110, the network computing device(s) 120, the configuration management device(s) 140, and/or a combination thereof. For ease of description, the method 600 may be described hereinafter as being performed by one of the above described devices, but it should be appreciated that other devices may be utilized to perform some or all of the described method 600.

At 605, the method 600 can include providing a plurality of communication security devices 110, which can include a first communication security device 110-1 in secure communication with a first network computing device 120-1, and a second communication security device 110-2 in secure communication with a second network computing device 120-2. At 610, a list of authorized communication devices can be established, for example by a configuration management device 140. The list of authorized communication devices can be stored at or otherwise be accessible by the communication security devices 110. The method can further include receiving (615), at the first communication security device 110-1, a communication packet 310, 410, 510 from the first network computing device 120-1, the communication packet 310, 410, 510 including first destination information that specifies that the communication packet is intended to be delivered to the second network computing device 120-2.

At 620, the first communication security device 110-1 can determine whether the first network computing device 120-1 is authorized to communicate with the second network computing device 120-2. As mentioned above, the determination can be based upon, inter alia, the destination information and the list of authorized communication devices. When it is determined that the first network computing device 110-1 is not authorized to communicate with the second network computing device 110-2, the first communication security device 110-1 can discard (625) the communication packet 310, 410, 510 without further passing it on.

When the first network computing device 120-1 is authorized to communicate with the second network computing device 120-2, the first communication security device 110-1 can encapsulate (630) the communication packet 310 to obtain an encapsulated communication packet 320. As mentioned above, the encapsulated communication packet 320 can comprise the original communication packet 310 as well as new destination information (second destination information) that specifies that the encapsulated communication packet 320 is intended to be delivered to the second communication security device 110-2 in order for the communication packet 310 to be delivered to the second network computing device 120-2. At 635, the first communication security device 110-1 can transmit the encapsulated communication packet 320 to the second communication security device 110-2.

Once the encapsulated communication packet 320 is received at the first second communication security device 110-2, the second communication security device 110-2 can de-encapsulate (640) the encapsulated communication packet 320 to obtain a de-encapsulated version 330 that, as described above, can be substantively be identical to the communication packet 310. Based on the de-encapsulated version 330/communication packet 310, the second communication security device 110-2 can determine (645) whether the first network computing device 120-1 is authorized to communicate with the second network computing device 120-2. When it is determined that the first network computing device 110-1 is not authorized to communicate with the second network computing device 110-2, the first communication security device 110-1 can discard (625) the de-encapsulated version 330/communication packet 310 without further passing it on. When the first network computing device 120-1 is authorized to communicate with the second network computing device 120-2, the second communication security device 110-2 can transmit (650) the de-encapsulated version 330/communication packet 310 to the second network computing device 120-2.

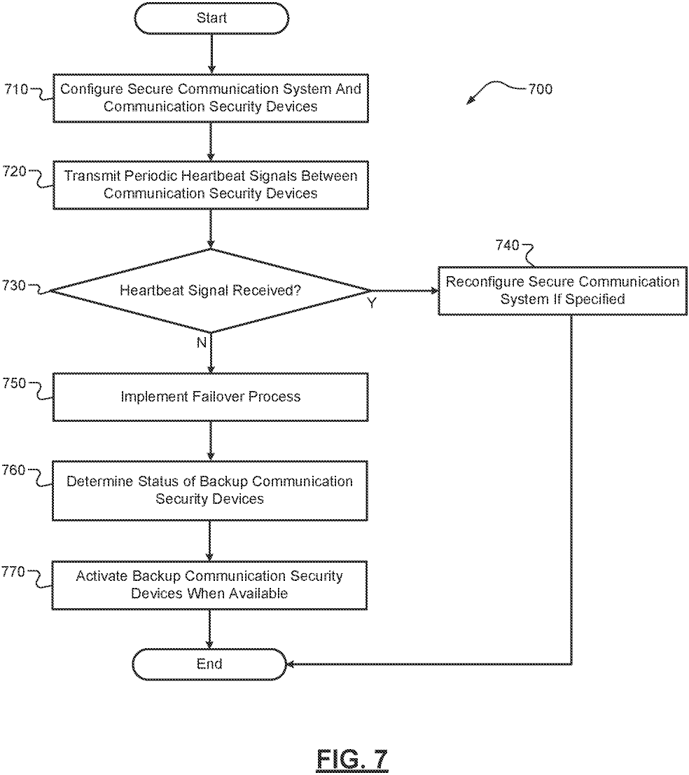

Referring now to FIG. 7, an example computer-implemented method 700 of providing a robust failover technique for a secure communication system 100 for securing communication between a plurality of network computing devices 120 over an unsecured network 130 is disclosed. The method 700 can be utilized with the method 600 described above. At 710, and as described more fully above, the secure communication system 100, including the communication security devices 110, can be configured and established to perform the method 600. At 720, the communication security devices 110 can transmit periodic heartbeat signals to each other and/or other devices in the system 100 (such as the one or more configuration management computing devices 140). The periodic heartbeat signals can be any type of signal that indicates to the system 100 which communication security devices 110 are active and running. In some aspects, the periodic heartbeat signals can be simple pings, but other signal types are contemplated.

At 730, it can be determined if a heartbeat signal has been received at a particular device (such as a communication security device 110). When the heartbeat signal is received, the secure communication system 100 can be reconfigured if the heartbeat signal specifies such an action. As mentioned above, the periodic heartbeat signals can be any type of signal that indicates to the system 100 which communication security devices 110 are active. When the periodic heartbeat signals indicates that a backup or currently inactive communication security device 110 is to be changed to an active state, the system 100 can be reconfigured (740) in this manner. If, however, the heartbeat signal does not specify a reconfiguration, the system 100 can continue to operate as configured.

If a heartbeat signal has not been received (730) at a particular device (such as a communication security device 110), a failover process (750) can be implemented by the system 100. For example only, if a heartbeat signal has not been received from an active communication security device (such as the first communication security device 110-1) when expected, the failover process (750) may assume that the active communication security device 110 is not operating as expected and the system 100 can attempt to change the status of a backup communication security device 110 to take over responsibility for the inoperable device. At 760, the status of a backup communication security device 110 can be determined by the system. When status of the backup communication security device 110 indicates that it is available, operating properly, or otherwise capable of changing to the active device, at 770 the backup communication security device 110 can be activated. The communication security system 100 can then continue to operate as intended with the newly active communication security device 110.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of securing communication between a plurality of network computing devices over an unsecured network, comprising:
providing a plurality of communication security devices, the plurality of communication security devices including: (i) a first communication security device in secure communication with a first network computing device of the plurality of network computing devices, and (ii) a second communication security device in secure communication with a second network computing device of the plurality of network computing devices;
establishing a list of authorized communication devices that specifies one or more computing devices with which each of the plurality of network computing devices are authorized to communicate;
receiving, at the first communication security device, a communication packet from the first network computing device, the communication packet including first destination information that specifies that the communication packet is intended to be delivered to the second network computing device;
determining, at the first communication security device and based on the destination information and the list of authorized communication devices, whether the first network computing device is authorized to communicate with the second network computing device;
when the first network computing device is authorized to communicate with the second network computing device:
encapsulating, at the first communication security device, the communication packet to obtain an encapsulated communication packet, the encapsulated communication packet comprising: (i) the communication packet, and (ii) second destination information that specifies that the encapsulated communication packet is intended to be delivered to the second communication security device in order for the communication packet to be delivered to the second network computing device,
transmitting, from the first communication security device and to the second communication security device over the unsecured network, the encapsulated communication packet,
de-encapsulating, at the second communication security device, the encapsulated communication packet to obtain the communication packet,
determining, at the second communication security device and based on the destination information and the list of authorized communication devices, whether the second network computing device is authorized to communicate with the first network computing device, and
when the second network computing device is authorized to communicate with the first network computing device, transmitting, from the second communication security device, the communication packet to the second network computing device.

2. The computer-implemented method of claim 1, further comprising, when the first network computing device is not authorized to communicate with the second network computing device, discarding the communication packet at the first communication security device without passing on the communication packet.

3. The computer-implemented method of claim 1, wherein the first communication security device is in secure communication with the first network computing device via a physical communication link.

4. The computer-implemented method of claim 1, wherein the list of authorized communication devices specifies which of the plurality of communication security devices is to be utilized to communicate with each of the plurality of network computing devices.

5. The computer-implemented method of claim 1, further comprising transmitting, from the first communication security device, a periodic heartbeat signal to the second communication security device, the periodic heartbeat signal indicating to the second communication security device that the first communication security device is in operation.

6. The computer-implemented method of claim 5, wherein the plurality of communication security devices includes a third communication security device in secure communication with the first network computing device of the plurality of network computing devices, the third communication security device comprising a backup to the first communication security device for secure communication with the first network computing device.

7. The computer-implemented method of claim 6, wherein the periodic heartbeat signal indicates which of the first communication security device or the third communication security device is to be used by the second communication security device to communicate with the first network computing device.

8. The computer-implemented method of claim 1, further comprising transmitting, from a configuration management device and to the plurality of communication security devices, a communication configuration that provides or updates the list of authorized communication devices.

9. The computer-implemented method of claim 1, wherein the first communication security device and the first network computing device are integrated into a single physical device.

10. The computer-implemented method of claim 1, wherein establishing the list of authorized communication destinations comprises storing the list of authorized communication destinations at each of the first and second communication security devices.

11. A secure communication system for securing communication between a plurality of network computing devices over an unsecured network, the system comprising:
a plurality of communication security devices, the plurality of communication security devices including: (i) a first communication security device in secure communication with a first network computing device of the plurality of network computing devices, and (ii) a second communication security device in secure communication with a second network computing device of the plurality of network computing devices,
wherein the system performs operations comprising:
establishes a list of authorized communication devices that specifies one or more computing devices with which each of the plurality of network computing devices are authorized to communicate;
receives, at the first communication security device, a communication packet from the first network computing device, the communication packet including first destination information that specifies that the communication packet is intended to be delivered to the second network computing device;
determines, at the first communication security device and based on the destination information and the list of authorized communication devices, whether the first network computing device is authorized to communicate with the second network computing device;
when the first network computing device is authorized to communicate with the second network computing device:
encapsulates, at the first communication security device, the communication packet to obtain an encapsulated communication packet, the encapsulated communication packet comprising: (i) the communication packet, and (ii) second destination information that specifies that the encapsulated communication packet is intended to be delivered to the second communication security device in order for the communication packet to be delivered to the second network computing device,
transmits, from the first communication security device and to the second communication security device over the unsecured network, the encapsulated communication packet,
de-encapsulates, at the second communication security device, the encapsulated communication packet to obtain the communication packet,
determine, at the second communication security device and based on the destination information and the list of authorized communication devices, whether the second network computing device is authorized to communicate with the first network computing device, and
when the second network computing device is authorized to communicate with the first network computing device, transmits, from the second communication security device, the communication packet to the second network computing device.

12. The secure communication system of claim 11, wherein the operations further comprise, when the first network computing device is not authorized to communicate with the second network computing device, discarding the communication packet at the first communication security device without passing on the communication packet.

13. The secure communication system of claim 11, wherein the first communication security device is in secure communication with the first network computing device via a physical communication link.

14. The secure communication system of claim 11, wherein the list of authorized communication devices specifies which of the plurality of communication security devices is to be utilized to communicate with each of the plurality of network computing devices.

15. The secure communication system of claim 1, wherein the operations further comprise transmitting, from the first communication security device, a periodic heartbeat signal to the second communication security device, the periodic heartbeat signal indicating to the second communication security device that the first communication security device is in operation.

16. The secure communication system of claim 15, wherein the plurality of communication security devices includes a third communication security device in secure communication with the first network computing device of the plurality of network computing devices, the third communication security device comprising a backup to the first communication security device for secure communication with the first network computing device.

17. The secure communication system of claim 16, wherein the periodic heartbeat signal indicates which of the first communication security device or the third communication security device is to be used by the second communication security device to communicate with the first network computing device.

18. The secure communication system of claim 11, further comprising a configuration management device, wherein the operations further comprise transmitting, from the configuration management device and to the plurality of communication security devices, a communication configuration that provides or updates the list of authorized communication devices.

19. The secure communication system of claim 11, wherein the first communication security device and the first network computing device are integrated into a single physical device.

20. The secure communication system of claim 11, wherein establishing the list of authorized communication destinations comprises storing the list of authorized communication destinations at each of the first and second communication security devices.
